(19) United States
(12) Patent Application Publication
(10) Pub. No.: US 2013/0056590 A1
(43) Pub. Date: Mar. 7, 2013

(54) EXTRUSION TAP TOP BEAM CLAMP

(71) Applicant: Scot Kennedy, Hilton Head, SC (US)

(72) Inventor: Scot Kennedy, Hilton Head, SC (US)

(21) Appl. No.: 13/695,846

(22) PCT Filed: May 26, 2011
(86) PCT No.: PCT/US2011/038130

§ 371 Date: Nov. 2, 2012

Related U.S. Application Data
(60) Provisional application No. 61/348,358, filed on May 26, 2010.

(51) Int. Cl. F16L 3/24; B23P 13/00

(52) U.S. Cl. 248/62; 29/558

(57) ABSTRACT

An improved beam clamp for use in hanging pipes and fire protection systems has a one piece clamp body with parallel arms which extend from a base for contact with a beam flange or other structure, and with one more through-holes formed in the base by friction drilling or other extrusion process to form a collar on one side of the base and a bushing on an opposite side of the base whereby the extruded through-hole has a linear dimension which is greater than a material thickness of the base. The extruded through-hole is threaded to receive a fastener or rod for extension to a pipe or other object, and the strength of the threaded engagement is increased by the number of threads in the extruded through-hole.

### RELATED APPLICATIONS

This is a national stage application from International Application No. PCT/US2011/038130, filed May 26, 2011, and claims priority to U.S. provisional patent application No. 61/348,358, filed on May 26, 2010, the entire contents of which are incorporated herein by reference.

### FIELD OF THE INVENTION

The present invention relates to clamps including beam clamps of the type used for hanging or suspension.

### BACKGROUND OF THE INVENTION

Conventionally, in the construction and modification of buildings, it is often desirable to suspend piping for water and sprinkler fire protection systems from the ceiling structure such as steel beams. A typical method for attaching a pipe to the ceiling utilizes the flanges of I-beams. Beam clamps of the type used for hanging pipe or other structural applications are installed on I-beam flanges by arms of the clamp which extend over a top surface of the flange and secured in place by a set screw which is threaded through the clamp body. A suspension rod may also be threaded through the clamp body proximate to the set screw and extends downward from the clamp body and beam to extend to a pipe or other object for suspension or other structural connection. This type of clamp is also referred to as a “top beam clamp”. There are strict construction and performance standards for fire protection systems which include and apply to beam clamp or pipe hanger equipment, such as UL 203 Pipe Hanger Equipment for Fire Protection Service by United Laboratories, Inc., and FM 1951, 1952 and 1953. These standards require in particular that the threaded engagement length of the rod in the clamp body be at least equal to the diameter of the rod. Accordingly, beam clamp bodies have been configured with forged or machined material thickness to meet this requirement, or an additional component has been used to meet the thickness requirement, such as by permanent attachment of a threaded nut to the clamp body. These designs and the required production steps add significantly to the cost of the part and to the total cost of standard-compliant fire protection systems.

### SUMMARY OF THE INVENTION

The present disclosure and related inventions provide a beam clamp which has a base; first and second parallel, spaced apart, generally L-shaped arms, each arm having an upper region and a lower region, the lower region extending from the base, and the upper region extending generally perpendicularly from the lower region; at least one extruded through-hole formed in the base, the at least one extruded through-hole having a collar on a first side of the base and a bushing which extends from a second side of the base which is opposite to the first side of the base, wherein a length of the bushing as measured from the second side of the base is equal to or greater than a thickness dimension of the base, and wherein the collar and bushing of the at least one extruded through-hole are formed from the material of the base.

The present disclosure and related inventions further provide a method of manufacture of a beam clamp which has: a base; first and second parallel, spaced apart, generally L-shaped arms, each arm having an upper region and a lower region, the lower region extending from the base, and the upper region extending generally perpendicularly from the lower region; at least one extruded through-hole formed in the base, the at least one extruded through-hole having a collar on a first side of the base and a bushing which extends from a second side of the base which is opposite to the first side of the base, wherein a length of the bushing as measured from the second side of the base is equal to or greater than a thickness dimension of the base, and wherein the collar and bushing of the at least one extruded through-hole are formed from the material of the base; the beam clamp manufactured by the steps of: cutting and forming a piece of metal to have the base and the first and second arms; formed the at least one extruded through-hole by friction drilling through base whereby the friction drilling forms the collar and the bushing from the piece of metal.

These and other aspects of the present disclosure and related inventions are further described herein with reference to the accompanying drawing figures which are illustrative of a representative embodiment.

### DESCRIPTION OF THE DRAWINGS

FIG. 1 is a first side elevation of a beam clamp of the present disclosure;

FIG. 2 is a first end view of the beam clamp of FIG. 1, in the direction of the arrows 2-2 in FIG. 1;

FIG. 3 is a second side elevation of the beam clamp of FIG. 1, in the direction of the arrows 3-3 in FIG. 1; and

FIG. 4 is an end view of the beam clamp of FIG. 1, in the direction of the arrows 4-4 in FIG. 3.

### DETAILED DESCRIPTION OF PREFERRED AND ALTERNATE EMBODIMENTS

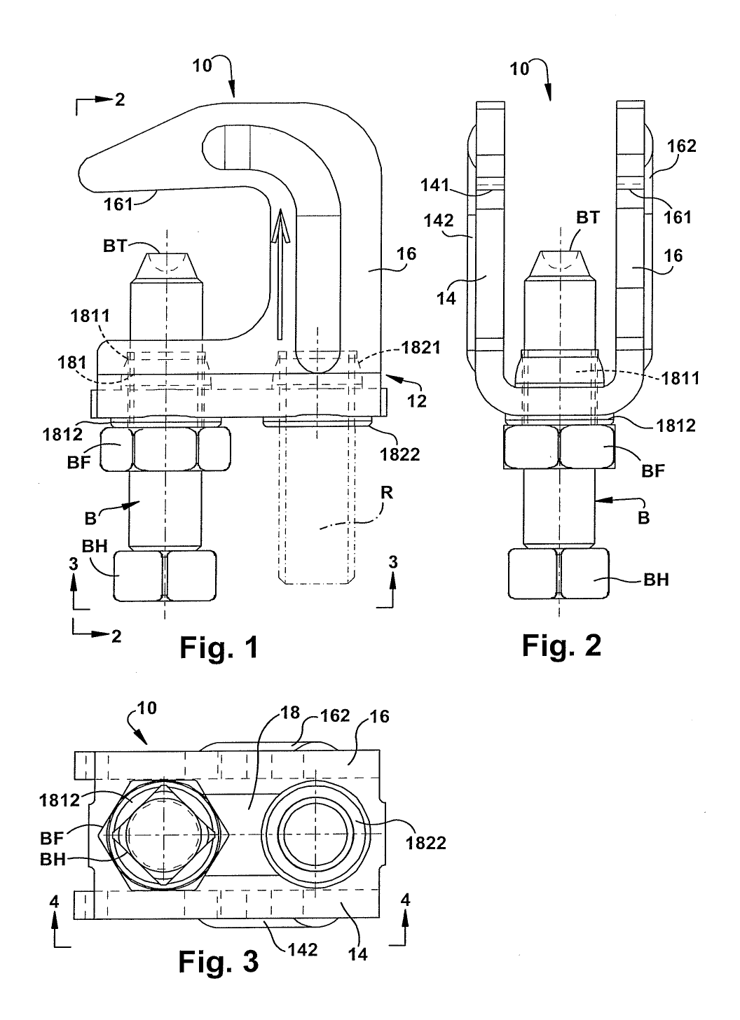

In a representative embodiment of the beam clamps of the disclosure and related inventions, as illustrated in the accompanying drawing FIGS. 1-4, a beam clamp, generally indicated at 10, has a clamp body 12 which is formed from a metal blank to form two generally symmetrical and parallel arms 14 and 16 which have a generally L-shaped profile as shown in FIG. 3. A base or web 18 extends between arms 14 and 16. Each arm 14, 16 has a lower region which extends from the base 18 and an upper region which extends generally orthogonal from the lower region and generally parallel to the base 18. Two threaded through-holes 181 and 182 are formed in the base 18, one to receive a mounting set screw, and the other to receive a rod for supporting a pipe or other object or structure. As further described, the clamp 10 is secured to an overhead support such as a building beam with the distal ends of the L-shaped arms 14, 16 positioned against an upper surface of the beam flange and the set screw tightened against the opposing underside of the beam flange, whereby a rod depends from the clamp body and the beam.

The base 18 joins the arms 14, 16 such that they are spaced apart, as shown in FIGS. 2 and 3, thereby providing space for the location of through-holes 181, 182. The spacing of arms 14, 16 improves the rotational stability of the clamp 10 with the respective beam contact surfaces 141, 161 in contact with the upper surface of a beam flange. Strengthening ribs 142, 162 may be formed in the respective arms 14, 16 to provide increased structural strength along a portion of or the entire length of each arm. The ribs 142, 162 can be formed on the interior and/or exterior surface(s) of the arms 14, 16, for example during formation of the clamp body 12 by stamping.

The clamp can be manufactured from a single piece of flat metal which is cut to the profile of the clamp body, formation of any reinforcing ribs, and then bent to form the arms 14 and 16. For example, the flat metal can be first blanked into the desired shape, and then subsequently bent (e.g., using a progressive die or the like) into the generally U-shaped configuration of the clamp body 12. It is understood that single piece of flat metal is described solely to indicate that its thickness is less than its length or width, to facilitate the bending process, and is not used to reflect any particular thickness specifications. Through-holes 181, 182 may be formed before or after the arms 14, 16 are bent into shape, as further described.

Through-hole 181 is formed in the base 18 to receive a set screw or bolt B as indicated, which may be externally threaded for engagement with threaded through-hole 181 to fasten the clamp 10 to the flange of an I-beam, with the bearing surfaces 141 and 161 of arms 14 and 16 against an upper surface of a beam flange, and the end BT of bolt B against the opposing lower surface of the beam flange. A locking fastener such as a nut, indicated at BF, can be provided on bolt B to lock its position once set against a beam or other structure to which the clamp is attached.

A second threaded through-hole 182 receives a threaded rod R which extends downwardly from the clamp 10 for attachment to a pipe or any other object or structure. The dimensions and spacing of the through-holes 181, 182 can be varied according to design parameters but are generally and preferably within the area of the base 18. Preferably, and according to applicable safety standards, the through-holes 181, 182 are threaded for engagement with the described fasteners and components, with a linear thread length at least equal to a diameter of the corresponding fastener or threaded component.

In a preferred embodiment and method of manufacture in accordance with the present disclosure and related inventions, through-holes 181, 182 are formed by a friction drilling process, also referred to in the alternative as high pressure drilling or friction stir drilling, all such processes, methods and equivalents are referred to herein in the alternative as an “extruded” or “extruded through-hole”. As used herein, the term “extruded” means and includes any process by which a hole and any other structures in or around a hole are formed by displacement of material in a piece or part and without removal of any material by cutting, punching or other process. Friction drilling is done with a rotating generally conical and non-fluted high strength steel tool tip that is forced into the material using a relatively high axial pressure and rotational speed. The tip or forming part of the tool has a generally polygonal shape with one or more facets. The facets create the friction while turning at high speeds. The heat generated by the friction heats the surrounding area and plasticizes the material so that it is malleable enough to be formed and perforated. Without removing any material, a hole is formed by the entering tool, similar to a forging process. As the drill presses into the material, some of the displaced material forms a collar or flange around the upper surface of the work piece about the periphery of the drilled hole, while the rest of the material forms a bushing in the lower surface of the work piece which depends from the hole in the direction of the drilling. Friction drill bits are configured with a conical tip with a rounded or flattened apex that transitions into a generally conical shape that transitions to a cylinder, and have one or more facets on the conical surface. The cylindrical portion of the bit determines the finished diameter of the hole. These and other variations of friction drilling or any other extrusion process by which the material of the piece, such as the steel of base 18, is used to form a through-hole with a bushing or bushing and collar are within the scope of the present disclosure.

In the case of through-holes 181 and 182, the corresponding bushings 1811 and 1821 and collars 1812 and 1822 shown in FIGS. 1 and 3 are formed by the described friction drilling methods. The formed collars 1812, 1822 increase the thickness of the base 18 about the through-holes 181, 182 and provide a seating surface for fasteners or components engaged with the through-holes as described. The bushings 1811, 1821 have a linear extent, measured from the surface of base 18 from which they extend, which can be equal to the thickness of the clamp body, such as for example 0.140+/−0.005 inches or as much as two or three times greater than the thickness of the clamp body or greater, depending upon such variables as the hole size, the type and configuration of friction drill tip used and the friction drilling operational parameters such as rotational speed, axial speed and pressure, and the type of material of the clamp body. The bushings 1811, 1821 and collars 1812, 1822 are formed by displacement of the clamp body material by the friction drilling process and without any cutting or removal of any of the clamp body material. The bushing 1811, 1821 can be further configured into threaded through-holes, used as a bearing support or surface, as a load bearing soldered or welded connection, or as a core hole sleeve for screw unions. To form threads within the through-holes 181, 182, a preferred method of this disclosure is by any suitable method which forms a continuous helical thread pattern through each of the collars 1812, 1822, through-holes 181, 182 and bushings 1811, 1822, such as by thread forming or cutting. Formation of threads by a forming process produces threads with superior strength as compared to conventional tap cutting methods. Friction tapping avoids cutting through the grain of the material and produces a high torque threaded structure with high pull out strength. However, thread forming by cutting or any other suitable method can be used in connection with the bushings 1811, 1822.

A preferred embodiment of the beam clamp 10 of the present disclosure has the following preferred dimensions: a nominal material thickness in an approximate range of 0.135 to 0.145 inches or more preferably 0.140 inches; a linear dimension measured from the surface of collar 1822 to a distal end of bushing 1822 is approximately 0.375 inches. Through-holes 181, 182 are threaded to receive a mating male threaded rod of 0.375 inch diameter. The linear extent of the threaded engagement of the rod R with through-hole 182 is thereby equal to or greater than the diameter of the rod R, in compliance with the applicable safety standards. The dimensions of this particular embodiment are representative only and do not otherwise limit the scope of the present disclosure or related inventions. For example, the diameter of either of the through-holes 181 or 182 as formed by the described friction drilling process may be within the range of 0.125 inch to 1.0 inch or greater.

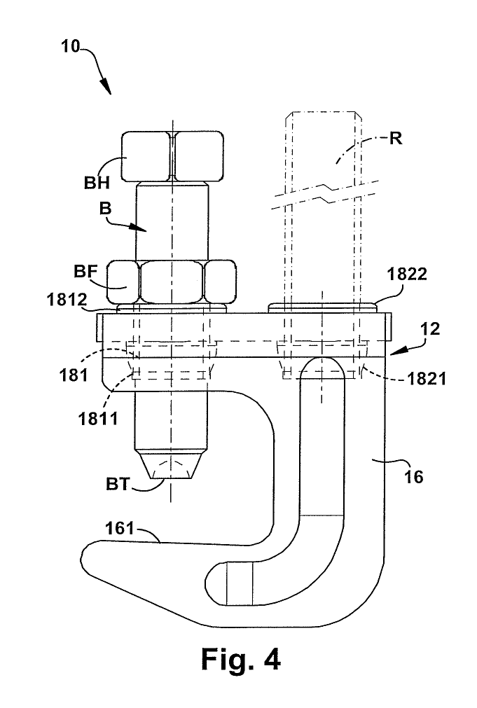

In use, the clamp 10 is installed onto the flange of an I-beam or T-bar, which flange may be for example up to 0.75 inches in thickness or greater. The clamp may be oriented so that the set screw S engages either the top or the bottom of the beam flange and the arms 14, 16 bear against the bottom or top of the beam flange, in the orientation shown in FIG. 1 or FIG. 4, respectively. The end of the threaded rod R which extends through the clamp body 12, i.e. through through-hole 181, may also be used as a connector for the beam clamp assembly by use of a fastener such as a nut or other compatible device on that end of rod R.

The clamp 10 can be made from various materials, such as high-strength, low-alloy (HSLA) steel. HSLA steel is a type of alloy steel that provides better mechanical properties (e.g., more formable, higher strength, etc.) and greater resistance to corrosion than conventional carbon steel. In a preferred embodiment the clamp 10 is made from cold rolled HSLA steel with a zinc plated finish for rust and corrosion resistance.

Novel clamps, clamp assemblies, and methods of manufacture are thus disclosed which provide an improved top beam-type clamp which is particularly well-suited for fire suppression and fire sprinkler systems and pipe support, and which meets all applicable standards including FM NFPA 13, UL 203 and Manufacturers Standardization Society SP-69, types 19 and 23 and federal specification WW-H-171E.

The invention has been described with reference to various example embodiments. Obviously, modifications and alterations will occur to others upon a reading and understanding of this specification. It is intended to include all such modifications and alterations.

What is claimed is:

1. A beam clamp comprising:
a base;
first and second parallel, spaced apart, generally L-shaped arms, each arm having an upper region and a lower region, the lower region extending from the base, and the upper region extending generally perpendicularly from the lower region;
at least one extruded through-hole formed in the base, the at least one extruded through-hole having a collar on a first side of the base and a bushing which extends from a second side of the base which is opposite to the first side of the base, wherein a length of the bushing as measured from the second side of the base is equal to or greater than a thickness dimension of the base, and wherein the collar and bushing of the at least one extruded through-hole are formed from the material of the base.

2. The beam clamp of claim 1, wherein the thickness dimension of the base is in an approximate range of 0.135 and 0.145 inches.

3. The beam clamp of claim 1, wherein the at least one extruded through-hole is formed with threads which extend in a generally helical path through the collar, the base and the bushing.

4. The beam clamp of claim 1, wherein the at least one extruded through-hole has a diameter in an approximate range of 0.350 inch to 1.00 inch or greater.

5. The beam clamp of claim 1, wherein the length of the at least one extruded through-hole as measured from the collar to a distal end of the bushing is equal to or greater than a diameter of the through-hole.

6. The beam clamp of claim 3 further comprising a threaded rod engaged with the at least one extruded through-hole.

7. The beam clamp of claim 1 further comprising a second extruded through-hole in the base proximate to the first extruded through-hole, the second extruded through-hole have a collar formed on one side of the base and a bushing formed on an opposite side of the base, wherein the collar and bushing of the second extruded through-hole are formed from the material of the base.

8. The beam clamp of claim 7 wherein the second extruded through-hole is formed with threads which extend in a generally helical path through the collar, the base and the bushing.

9. The beam clamp of claim 8 further comprising a threaded bolt engaged with the second extruded through-hole.

10. The beam clamp of claim 9 wherein the at least one extruded through-hole and the second extruded through-hole are identically formed.

11. The beam clamp of claim 1 further comprising electroplating over the entire beam clamp including the extruded through-hole collar and bushing.

12. The beam of claim 1 made of HSLA steel.

13. The beam clamp of claim 1 wherein the bushing depends from a surface of the base a distance equal to or greater than a diameter of the at least one extruded through-hole.

14. The beam clamp of claim 1 wherein the at least one extruded through-hole and the collar and bushing are formed in a substantially planar are of the base.

15. The beam clamp of claim 1 wherein the at least one extruded through-hole is generally aligned with the lower regions of the arms which extend from the base.

16. The beam clamp of claim 1 further comprising at least one rib in at least one of the first and second arms.

17. A method of manufacture of a beam clamp comprising:
a base;
first and second parallel, spaced apart, generally L-shaped arms, each arm having an upper region and a lower region, the lower region extending from the base, and the upper region extending generally perpendicularly from the lower region;
at least one extruded through-hole formed in the base, the at least one extruded through-hole having a collar on a first side of the base and a bushing which extends from a second side of the base which is opposite to the first side of the base, wherein a length of the bushing as measured from the second side of the base is equal to or greater than a thickness dimension of the base, and wherein the collar and bushing of the at least one extruded through-hole are formed from the material of the base;
the beam clamp manufactured by the steps of:
cutting and forming a piece of metal to have the base and the first and second arms;
formed the at least one extruded through-hole by friction drilling through base whereby the friction drilling forms the collar and the bushing from the piece of metal.

18. The method of claim 17 further comprising the step of forming threads in the at least one extruded through-hole.

19. The method of claim 18 further comprising the step of forming threads in the at least one extruded through-hole by friction tapping.

20. The method of claim 18 further comprising the step of forming a second extruded through-hole in the base by friction drilling.

21. The method of claim 18 further comprising the step of plating the beam clamp after formation of the at least one extruded through-hole.
